(19) United States
(12) Patent Application Publication
(10) Pub. No.: US 2015/0184451 A1
(43) Pub. Date: Jul. 2, 2015

(54) CONTROL ASSEMBLY FOR CORDLESS CURTAIN ASEMBLY

(71) Applicant: CHING FENG HOME FASHIONS CO., LTD.

(72) Inventors: SHENG-YING HSU, Fuxing Shiang (TW); CHUN JAN HSU, Fuxing Shiang (TW)

(21) Appl. No.: 14/242,890

(22) Filed: Apr. 2, 2014

(30) Foreign Application Priority Data
Dec. 30, 2013 (TW) 102224758

(51) Int. Cl. E06B 9/30

(52) U.S. Cl. CPC E06B 9/30

(57) ABSTRACT

A cordless curtain assembly includes a curtain body connected between the head box and the bottom bar. A controller, a fixed unit and a movably unit are located in the head box. The movable unit is movably located between the controller and the fixed unit. A driving rope has a first end fixed to the bottom bar and the second end of the driving rope goes through the curtain body and the head box, and is wrapped to the guide members of the movable unit and the fixed unit. The second end of the driving rope then extends through the head box and through the curtain body and is eventually fixed to the bottom bar. A resilient rope has one end fixed to the movable part and the second end of the resilient ripe goes over the pulley in the controller and is fixed to the fixed unit.

### FIELD OF THE INVENTION

The present invention is a curtain assembly and more particularly, to a control assembly for a cordless curtain assembly with simple structure.

### BACKGROUND OF THE INVENTION

A conventional curtain assembly generally comprises a curtain body, a control assembly and a control cord, wherein the control assembly is located in the head box and connected with the control cord. When the user pulls the control cord, the curtain body is moved upward or downward relative to the operation of the control assembly and the control cord. However, the conventional control assembly of the curtain assembly involves a complicated structure. The control cord is connected to the control assembly, if the user pulls the control cord too hard or releases the control cord too quickly, the curtain cannot be properly positioned at the desired position because the friction between the control cord and the parts that the control cord passes generate resistance. The user has to operate the control cord to adjust the position of the curtain several times.

Besides, the control assembly includes many parts and is complicate in structure. The connection between the control assembly and the control cord is complicated and the manufacturing cost is high.

The present invention intends to provide a control assembly of a cordless curtain assembly, the control assembly is simple and the manufacturing cost is reduced.

### SUMMARY OF THE INVENTION

The present invention relates to a control assembly of a cordless window curtain assembly, and comprises a controller having a pulley connected thereto and a resilient rope goes over the pulley. The resilient rope has a first end and a second end. A fixed unit is located in the head box of the window curtain assembly and has a first passage defined therethrough. Two first guide members, a first rod and multiple columns are located in the first passage. The second end of the resilient rope is fixed to the first rod. A movable unit is located between the controller and the fixed unit. The movable unit has a second passage defined therethrough. Two second guide members and a second rod are located in the second passage. Multiple rollers are connected to two sides of the movable unit. The first end of the resilient rope is fixed to the second rod. A driving rope has a first end and a second end. The first end of the driving rope is fixed to the bottom bar of the curtain assembly. The second end of the driving rope extends through the curtain body connected between the head box and the bottom bar and are wrapped to the two first guide members in the fixed unit and the two second guide members of the movable unit. The second end of the driving rope eventually extends through the head box, the curtain body and is fixed to the bottom bar.

Preferably, the axis of the pulley is perpendicular to the axis of the head box.

Alternatively, the present invention provides a cordless curtain assembly and comprises a head box and a bottom bar, and a curtain body is connected between the head box and the bottom bar. The head box has a space defined therein and two holes are defined through the bottom board of the head box. A controller is located in the space of the first end of the head box and has a pulley connected thereto. A resilient rope goes over the pulley. The resilient rope has a first end and a second end. A fixed unit is located in the space of the second end of the head box of the curtain assembly and has a first passage defined therethrough. Two first guide members, a first rod and multiple columns are located in the first passage. The second end of the resilient rope is fixed to the first rod. A movable unit is located between the controller and the fixed unit. The movable unit has a second passage defined therethrough. Two second guide members and a second rod are located in the second passage. Multiple rollers are connected to two sides of the movable unit and are movable along two opposite insides of the space of the head box. The first end of the resilient rope is fixed to the second rod. A driving rope has a first end and a second end. The first end of the driving rope is fixed to the bottom bar of the curtain assembly. The second end of the driving rope extends through the curtain body connected between the head box and the bottom bar and are wrapped to the two first guide members in the fixed unit and the two second guide members of the movable unit. The second end of the driving rope eventually extends through the head box, the curtain body and is fixed to the bottom bar.

Preferably, the curtain body comprises multiple slats.

Preferably, the axis of the pulley is perpendicular to the axis of the head box.

Preferably, the controller includes a U-shaped frame which has two sidewalls extending from two sides of a transverse board, the transverse board is fixed to the head box, the pulley is connected between the two sidewalls of the U-shaped frame, the U-shaped frame has an open top which communicates with an open top of the head box so that the resilient rope is exposed to the open top of the U-shaped frame and the open top of the head box.

The primary object of the present invention is to provide a control assembly for a cordless curtain assembly wherein the control assembly has simple structure and is easily operated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the control assembly of the cordless curtain assembly of the present invention;

FIG. 2 is a bottom cross sectional view of the control assembly of the cordless curtain assembly of the present invention;

FIG. 3 is a top cross sectional view of the control assembly of the cordless curtain assembly of the present invention;

FIG. 4 shows that the curtain body of the cordless curtain assembly of the present invention is lowered, and

FIG. 5 shows that the curtain body of the cordless curtain assembly of the present invention is lifted.

### DETAILED DESCRIPTION OF THE PREFERRED EMBODIMENT

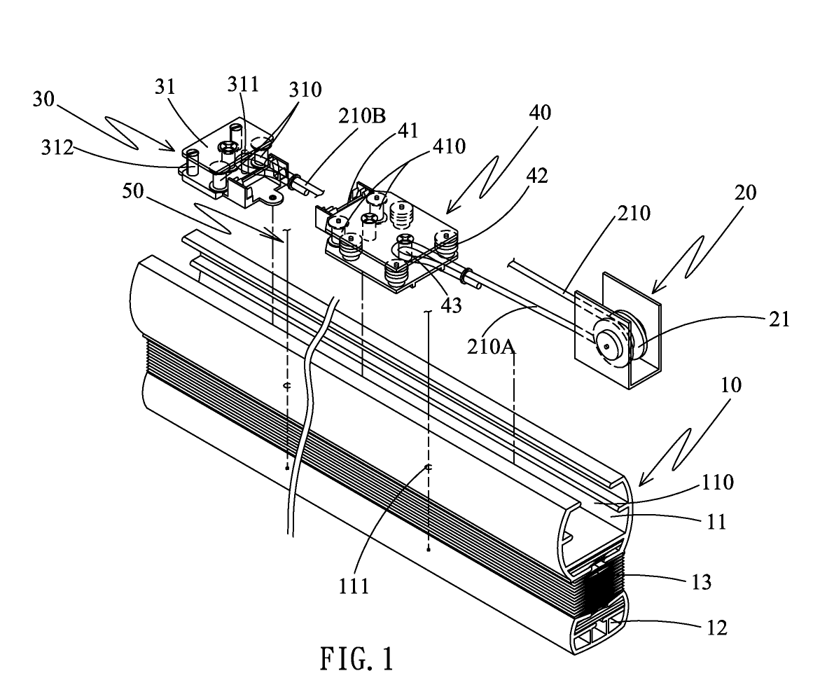

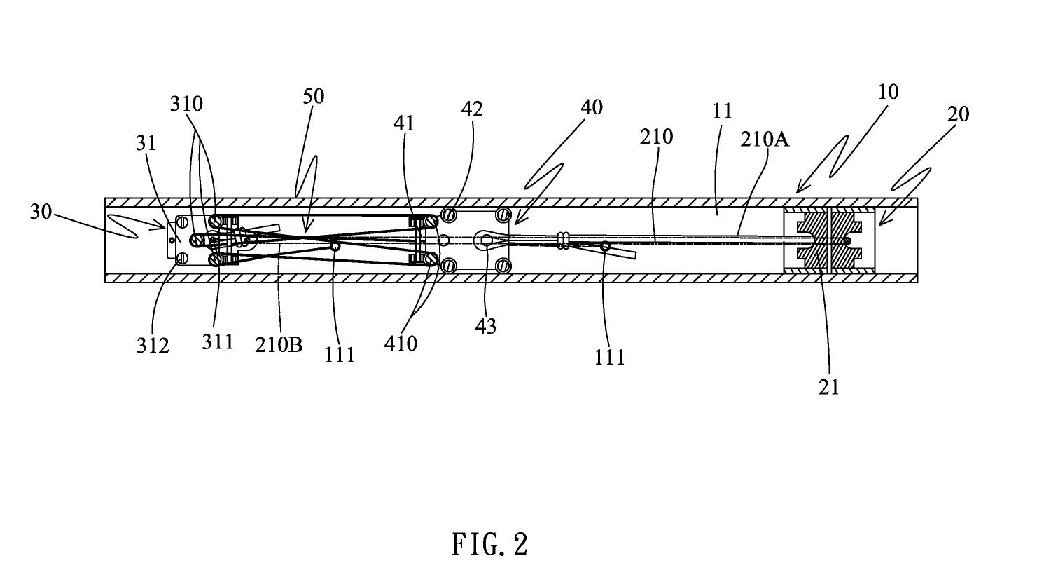

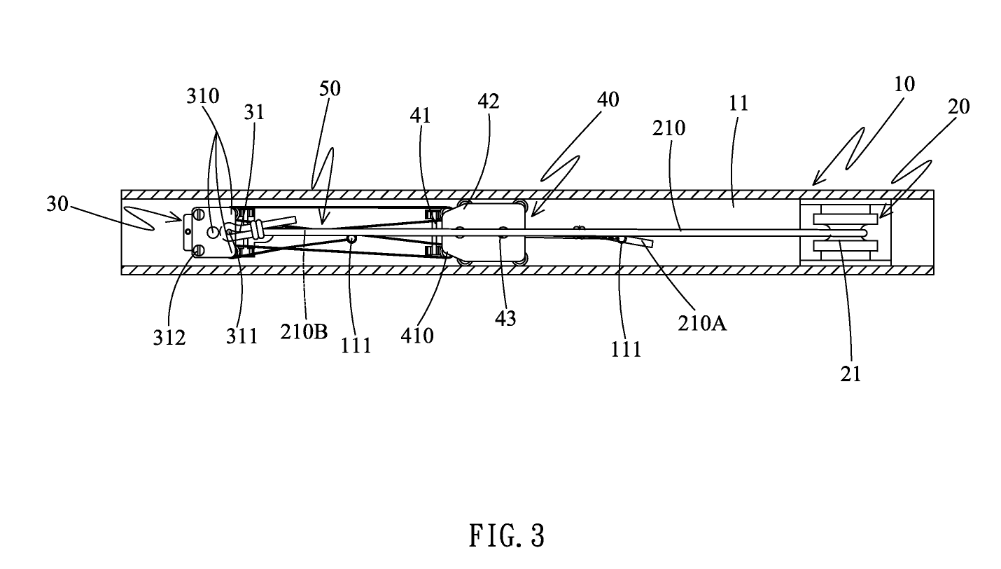

Referring to FIGS. 1 to 3, the cordless curtain assembly 10 of the present invention comprises a head box 11 and a bottom bar 12, and a curtain body 13 is connected between the head box 11 and the bottom bar 12. The head box 11 has a space 110 defined therein and two holes 111 are defined through the bottom board of the head box 11. The curtain body 13 comprises multiple slats or honey-comb units which are connected to each other.

A controller 20 is located in the space 110 and securely connected to the first end of the head box 11. The controller 20 includes a U-shaped frame which has two sidewalls extending from two sides of a transverse board. The transverse board is fixed to the head box 11 and a pulley 21 is connected between the two sidewalls of the U-shaped frame. The U-shaped frame has an open top which communicates with the open top of the head box 11. A resilient rope 210 goes over the pulley 21 and has a first end 210A and a second end 210B. The axis of the pulley 21 is perpendicular to the axis of the head box 11.

A fixed unit 30 is located in the space 110 and securely connected to the second end of the head box 11. The fixed unit 30 includes a top plate and a bottom plate. A first passage 31 is defined between the top and bottom plates. Two first guide members 310, one first rod 311 and multiple columns 312 are located in the first passage 31. The second end 210B of the resilient rope 210 extend over the movable unit 40 which will be described later, and is fixed to the first rod 311.

The movable unit 40 is located in the space 110 and between the controller 2 and the fixed unit, 30. The movable unit 40 includes a top plate and a bottom plate. A second passage 41 is defined between the top and bottom plates of the movable unit 40. Two second guide members 410 and multiple second rods 43 are located in the second passage 41. Multiple rollers 42 are connected to two sides of the movable unit 40. The movable unit 40 is movable between the controller 2 and the fixed unit, 30. The rollers 42 roll along two flanges on the two opposite insides of the head box 11 so that the movable unit 40 can be moved smoothly with less resistance. The first end 210A of the resilient rope 210 is fixed to the second rod 43.

A driving rope 50 has a first end and a second end. The first end of the driving rope 50 is fixed to the bottom bar 12, and the second end of the driving rope 50 extends through the curtain body 13 and one of the holes 111 of the head box 11 so as to enter into the space 110 of the head box 11, and then the second end of the driving rope 50 is wrapped to the two first guide members 310 in the fixed unit 30 and the two second guide members 410 of the movable unit 40 in a back-and-forth form. The second end of the driving rope 50 eventually then extends through the other hole 111 of the head box 11, the curtain body 13 and is fixed to the bottom bar 12.

The controller 20 and the fixed unit 30 are located in the space 110 and respectively and securely connected to the first and second ends of the head box 11. The movable unit 40 is movably located between the controller 20 and the fixed unit 30. The resilient rope 210 goes over the pulley 21 of the controller 20 and the second end 210B of the resilient rope 210 is fixed to the first rod 311, and the first end 210A of the resilient rope 210 is fixed to the second rod 43. The rollers 42 of the movable unit 40 roll along the two flanges on the two opposite insides of the head box 11 so that the movable unit 40 can be moved smoothly with less resistance.

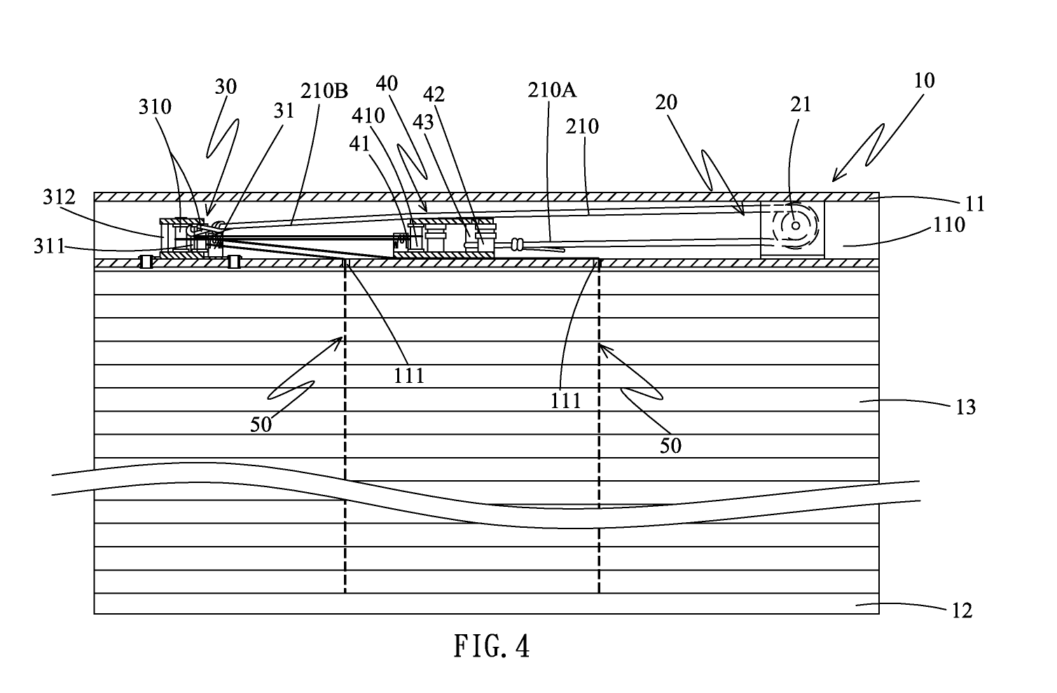

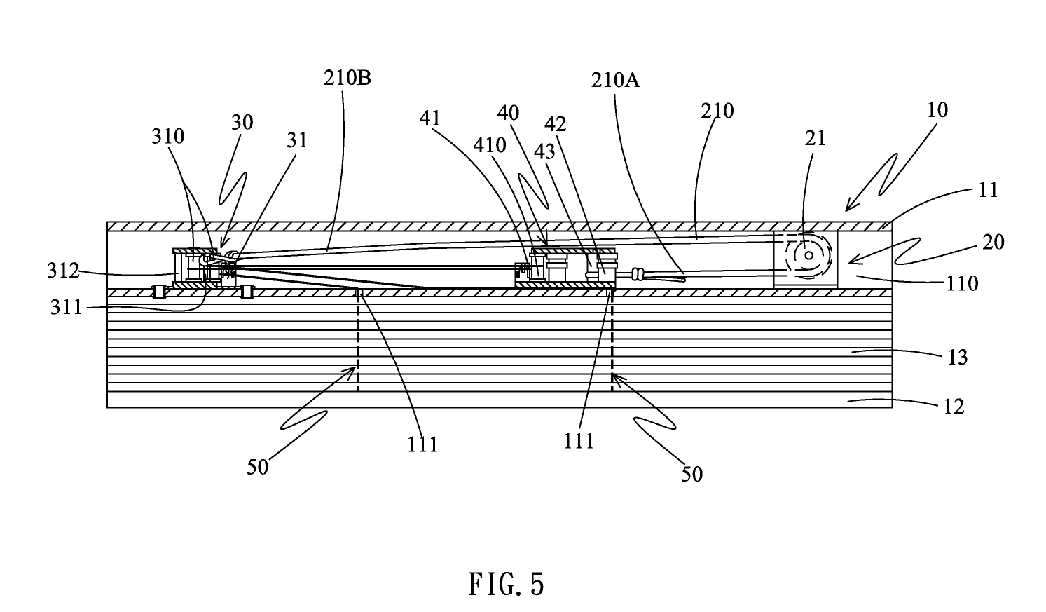

As shown in FIG. 4, by pulling the bottom bar 12 downward, the resilient rope 210 is stretched and the movable unit 40 moves toward the fixed unit 30. The driving rope 50 is pulled away from the head box 11 so that the curtain 13 is expanded and lowered. On the contrary, as shown in FIG. 5, when lifting the bottom bar 12, the driving rope 50 is loosened and the resilient rope 210 is re-scrolled to move the movable unit 40 moves away from the fixed unit 30. The driving rope 50 is lifted so that the curtain body 13 is lifted.

The structure of the control assembly of the cordless curtain assembly 10 is simple, the assembling steps of the control assembly is easy as well. The axis of the pulley 21 is perpendicular to the axis of the head box 11 so that when maintaining the control assembly, the resilient rope 210 is easily accessed from the open top of the head box 11.

While we have shown and described the embodiment in accordance with the present invention, it should be clear to those skilled in the art that further embodiments may be made without departing from the scope of the present invention.

What is claimed is:

1. A control assembly of a cordless curtain assembly, comprising:
a controller having a pulley connected thereto and a resilient rope going over the pulley, the resilient rope having a first end and a second end;
a fixed unit having a first passage defined therethrough and two first guide members, a first rod and multiple columns located in the first passage, the second end of the resilient rope fixed to the first rod;
a movable unit located between the controller and the fixed unit, the movable unit having a second passage defined therethrough, two second guide members and a second rod located in the second passage, multiple rollers connected to two sides of the movable unit, the first end of the resilient rope fixed to the second rod, and
a driving rope having a first end and a second end, the first end of the driving rope fixed to a bottom bar of the curtain assembly, the second end of the driving rope extending through a curtain body connected between the head box and the bottom bar, and wrapped to the two first guide members in the fixed unit and the two second guide members of the movable unit, the second end of the driving rope extending through the head box, the curtain body and being fixed to the bottom bar.

2. The cordless window curtain as claimed in claim 1, wherein an axis of the pulley is perpendicular to an axis of the head box.

3. A cordless curtain assembly comprising:
a head box and a bottom bar, a curtain body connected between the head box and the bottom bar, the head box having a space defined therein and two holes defined through a bottom board of the head box;
a controller located in the space and fixedly connected to a first end of the head box, the controller having a pulley and a resilient rope going over the pulley, the resilient rope having a first end and a second end;
a fixed unit located in the space and securely connected to a second end of the head box, the fixed unit having a first passage defined therethrough and two first guide members located in the first passage of the fixed unit, a first rod and multiple columns located in the first passage, the second end of the resilient rope fixed to the first rod;
a movable unit movably located in the space and between the controller and the fixed unit, the movable unit having a second passage defined therethrough, two second guide members and a second rod located in the second passage, multiple rollers connected to two sides of the movable unit, the rollers rolling along two opposite insides of the space of the head box, the first end of the resilient rope fixed to the second rod, and
a driving rope having a first end and a second end, the first end of the driving rope fixed to the bottom bar, the second end of the driving rope extending through the curtain body and wrapped to the two first guide members in the fixed unit and the two second guide members of the movable unit, the second end of the driving rope extending through the head box, the curtain body and being fixed to the bottom bar.

4. The cordless window curtain as claimed in claim 3, wherein the curtain body comprises multiple slats.

5. The cordless window curtain as claimed in claim 3, wherein an axis of the pulley is perpendicular to an axis of the head box.

6. The cordless window curtain as claimed in claim 3, wherein the controller includes a U-shaped frame which has two sidewalls extending from two sides of a transverse board, the transverse board is fixed to the head box, the pulley is connected between the two sidewalls of the U-shaped frame, the U-shaped frame has an open top which communicates with an open top of the head box so that the resilient rope is exposed to the open top of the U-shaped frame and the open top of the head box.
